(19) United States
(12) Patent Application Publication
(10) Pub. No.: US 2016/0318065 A1
(43) Pub. Date: Nov. 3, 2016

(54) Transferrable Shadow Cure Method

(71) Applicant: University of Iowa Research Foundation, Iowa City, IA (US)

(72) Inventors: Sage M. Schissel, Ossian, IA (US); Sara M. Kaalberg, Bettendorf, IA (US); Julie L.P. Jessop, Iowa City, IA (US)

(21) Appl. No.: 15/141,800

(22) Filed: Apr. 28, 2016

Related U.S. Application Data
(60) Provisional application No. 62/154,075, filed on Apr. 28, 2015.

(51) Int. Cl. B05D 3/06; C08G 59/02; F21V 8/00; C08G 59/22

(52) U.S. Cl. CPC B05D 3/061; C08G 59/22; C08G 59/022; G02B 6/0005

(57) ABSTRACT

Photo-polymerizable compositions for preparing a polymer are described, wherein the composition includes a cationically polymerizable monomer and a photo-initiating system comprising a cationic photo-initiating agent. The compositions are amenable for use in methods directed to producing polymers that cure in sites in which light penetration is not possible for inducing photo-polymerization of polymers for many applications, such as, for example, where the polymer is made in an opaque mold; where the polymerizable composition includes interfering substances such as pigments, dyes and/or fillers; where the polymer shape is thick; where the polymerizable composition needs to fill a sample having long crevices or molds with complicated shapes, angles or deep cracks and to encapsulate complex parts; or where the polymerizable composition needs to bond or adhere two substrates that may be opaque, semi-transparent, or optically thick. An apparatus and reaction vessel for forming the photo-polymerizable compositions are also described.

### CROSS-REFERENCE TO RELATED APPLICATIONS

This application claims benefit of priority under 35 U.S.C. 119 to U.S. provisional patent application Ser. No. 62/154,075, filed Apr. 28, 2015, and entitled “TRANSFERRABLE SHADOW CURE METHOD,” the contents of which are herein incorporated by reference in its entirety.

### FIELD

The present disclosure relates generally to methods for making polymers by photo-polymerization.

### BACKGROUND

Methods of forming polymers using photo-polymerization techniques are well known in the art. Yet, many sites in which light penetration is not possible limits photo-polymerization of polymers for many applications, such as, for example, where the polymer is made in an opaque mold; where the polymerizable composition includes interfering substances such as pigments, dyes and/or fillers; where the polymer shape is thick; where the polymerizable composition needs to fill a sample having long crevices or molds with complicated shapes, angles or deep cracks and to encapsulate complex parts; or where the polymerizable composition needs to bond or adhere two substrates that may be opaque, semi-transparent, or optically thick. Likewise, photo-polymerization has limited application for forming polymers for in vivo applications where the UV light illumination conditions required for photo-polymerization are detrimental to living material, such as cellular genetic and protein material.

### BRIEF SUMMARY

In a first aspect, a photo-polymerizable composition for preparing a polymer is provided. The photo-polymerizable composition includes a cationically polymerizable monomer and a photo-initiating system including a cationic photo-initiating agent.

In a second aspect, a method of forming a photo-polymerized polymer on a substrate is provided. The method includes several steps. The first step includes preparing a first mixture that includes a cationically polymerizable monomer and photo-initiating system including a cationic photo-initiating agent. The second step includes irradiating the first mixture with UV and/or visible light to form a second mixture. The second mixture comprises a solid polymer and an activated monomer liquid. The third step includes removing the solid polymer from the activated monomer liquid in the second mixture to provide an isolated activated monomer liquid. The fourth step includes contacting the isolated activated monomer liquid to a substrate. The activated monomer liquid forms the photo-polymerized polymer on the substrate.

In a third aspect, a product is provided, wherein the product produced according to the method of the second aspect.

In a fourth aspect, an apparatus for forming a photo-polymerized polymer is provided. The apparatus includes a barrel with a first cavity; a plunger with a second cavity, wherein the plunger is disposed in the first cavity; a light guide optic fiber positioned in the second cavity; and a radiation source. The light guide optic fiber is in optical communication with the radiation source.

In a fifth aspect, a reaction vessel for forming a photo-polymerized polymer is provided. The reaction vessel includes two components. The first component includes a barrel having a first cavity, wherein a mesh is disposed at an open end of the first cavity. The second component includes a plunger having a second cavity, wherein the plunger is disposed in the first cavity.

These and other features, objects and advantages of the present invention will become better understood from the description that follows. In the description, reference is made to the accompanying drawings, which form a part hereof and in which there is shown by way of illustration, not limitation, embodiments of the invention.

### BRIEF DESCRIPTION OF THE DRAWINGS

The features, objects and advantages other than those set forth above will become more readily apparent when consideration is given to the detailed description below. Such detailed description makes reference to the following drawings.

FIG. 1A depicts a polydimethylsiloxane (PDMS) mold used in shadow cure experiments.

FIG. 1B depicts an example of the curing set-up for a shadow cure sample. Although the entire channel is filled with the monomer formulation, only a small area is exposed to the UV/visible light.

FIG. 2 depicts an example of a shadow-cure sample, from different angles (subpanels (i), (ii) and (iii)), made using the original method (in which the light-cured section is not removed). For reference, the height of the sample is approximately 9 mm.

FIG. 3A depicts a side view of the crevice mold without sides.

FIG. 3B depicts a top view of the crevice mold without sides.

FIG. 3C depicts a top view of the crevice mold with sides. In FIGS. 3A-C, the monomer formulation fills both the “well” on the left-hand side, as well as the crevice that runs the length of the mold. Only the top of the “well” is exposed to light.

FIG. 4 depicts an example of a shadow-cure sample, from different angles (subpanels (i) and (ii)), made using the crevice mold. For reference, the height of the sample is approximately 14 mm.

FIG. 5A depicts a reduced channel size used in a preferred aspect of the method.

FIG. 5B depicts an example of the liquid resin filling the entire length of the mold post-illumination, after the light-cured section and hot glue are removed.

FIG. 6A depicts an example of a shadow-cure sample made using a preferred aspect of the method (approximately 4 cm long).

FIG. 6B depicts an example of a preferred aspect of the method applied to a complicated mold with multiple angles.

FIG. 7A presents an exemplary response profile where the factor levels of exposure time and exposure area were set to 0 (that is, exposure time was 5.5 minutes and exposure area was 0.5 cm² for all samples tested as a function of effective irradiance and sample depth).

FIG. 7B presents an exemplary response profile where the factor levels of effective irradiance and exposure area were set to 0 (that is, effective irradiance was 55 mW/cm² and exposure area was 0.5 cm² for all samples tested as a function of exposure time and sample depth).

FIG. 8 depicts an example of a preferred embodiment of an apparatus for forming a photo-polymerized polymer according to the methods presented herein.

FIG. 9 depicts an exemplary embodiment of forming a photo-polymerized polymer in a mold according the methods presented herein.

While the present invention is amenable to various modifications and alternative forms, exemplary embodiments thereof are shown by way of example in the drawings and are herein described in detail. It should be understood, however, that the description of exemplary embodiments is not intended to limit the invention to the particular forms disclosed, but on the contrary, the intention is to cover all modifications, equivalents and alternatives falling within the spirit and scope of the invention as defined by the embodiments above and the claims below. Reference should therefore be made to the embodiments and claims herein for interpreting the scope of the invention.

### DETAILED DESCRIPTION

The compositions and methods now will be described more fully hereinafter with reference to the accompanying drawings, in which some, but not all permutations and variations of embodiments of the invention are shown. Indeed, the invention may be embodied in many different forms and should not be construed as limited to the embodiments set forth herein. These embodiments are provided in sufficient written detail to describe and enable one skilled in the art to make and use the invention, along with disclosure of the best mode for practicing the invention, as defined by the claims and equivalents thereof.

Likewise, many modifications and other embodiments of the compositions and methods described herein will come to mind to one of skill in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

### GLOSSARY OF TERMS AND DEFINITIONS

Unless defined otherwise, all technical and scientific terms used herein have the same meaning as commonly understood by one of skill in the art to which the invention pertains. Although any methods and materials similar to or equivalent to those described herein can be used in the practice or testing of the present invention, the preferred methods and materials are described herein.

Moreover, reference to an element by the indefinite article “a” or “an” does not exclude the possibility that more than one element is present, unless the context clearly requires that there be one and only one element. The indefinite article “a” or “an” thus usually means “at least one.”

As used herein, “about” means within a statistically meaningful range of a value or values such as a stated concentration, length, molecular weight, pH, sequence identity, time frame, temperature or volume. Such a value or range can be within an order of magnitude, typically within 20%, more typically within 10%, and even more typically within 5% of a given value or range. The allowable variation encompassed by “about” will depend upon the particular system under study, and can be readily appreciated by one of skill in the art.

Ranges recited herein include the defined boundary numerical values as well as sub-ranges encompassing any non-recited numerical values within the recited range. For example, a range from about 0.01 mM to about 10.0 mM includes both 0.01 mM and 10.0 mM. Non-recited numerical values within this exemplary recited range also contemplated include, for example, 0.05 mM, 0.10 mM, 0.20 mM, 0.51 mM, 1.0 mM, 1.75 mM, 2.5 mM 5.0 mM, 6.0 mM, 7.5 mM, 8.0 mM, 9.0 mM, and 9.9 mM, among others. Exemplary sub-ranges within this exemplary range include from about 0.01 mM to about 5.0 mM; from about 0.1 mM to about 2.5 mM; and from about 2.0 mM to about 6.0 mM, among others.

The term “radiation source” refers to a source that generates UV or visible light, or combinations of UV and visible light.

The term “optical communication” refers to transmission of light from a radiation source to a target.

The term “light-cured section” refers to a solid polymer formed in the mixture (cationically polymerizable monomer and cationic photo-initiator) in the area exposed to light.

### Shadow Curing Methods and Compositions

A robust shadow curing method for preparing polymers is provided, wherein the polymers are formed by transference of cationic active centers generated from selective illumination of a monomer formulation. The removal of the solid polymer formed in the area exposed to light enables further polymerization to occur via the activated monomers. The method achieves polymer shadow curing by separating the photo-initiation step from the propagation step in cationic photo-polymerizations and relies on the long-lived nature of cationic active centers to generate conversion of the polymer sample that cannot be directly illuminated. The light-cured section is removed after illumination so that the remaining formulation can shadow cure fully (either in the mold or be transferred to a different mold or application). An incomplete shadow cure results if the light-cured section remains (i.e., liquid resin remains in the mold with small portions of polymer formed). The resultant polymers can include certain additives or a higher concentration of other additives that would preclude polymer formation by other photo-polymerization methods.

In a first aspect, a photo-polymerizable composition for preparing a polymer is provided. The photo-polymerizable composition includes a cationically polymerizable monomer and a photo-initiating system including a cationic photo-initiating agent. In one respect, the photo-initiating system excludes at least one member selected from a group consisting of a photo-sensitizing agent and a peroxide, or a combination thereof. Thus, the composition is robust owing to its simplicity.

In some respects, the cationically polymerizable monomer includes preferably 3,4-epoxycyclohexylmethyl 3,4-epoxycyclohexanecarboxylate (EEC). Other cationically polymerizable monomers suitable for inclusion in the composition are known in the art, such as vinyl ethers, styrene, N-vinylcarbazole, epoxy monomers, cyclic ethers, lactones, and cyclic acetals. In some respects, the cationic photo-initiating agent includes preferably a diaryliodonium hexafluoroantimonate, such as [4-(2-hydroxyl-1-tetradecyloxy)-phenyl] phenyliodonium hexafluoroantimonate (DAI). Other cationic photo-initiating agents suitable for inclusion in the composition are known in the art, such as diazonium salts, onium salts, and organometallic derivatives. In some respects, the photo-polymerizable composition includes cationically polymerizable monomer including 3,4-epoxycyclohexylmethyl 3,4-epoxycyclohexanecarboxylate (EEC) and a cationic photo-initiating agent including a diaryliodonium hexafluoroantimonate, such as [4-(2-hydroxyl-1-tetradecyloxy)-phenyl] phenyliodonium hexafluoroantimonate (DAI).

In a second aspect, a method of forming a photo-polymerized polymer on a substrate is provided. The method includes several steps. The first step includes preparing a first mixture that includes a cationically polymerizable monomer and a photo-initiating system including a cationic photo-initiating agent. The second step includes irradiating the first mixture with UV and/or visible light to form a second mixture. The second mixture comprises a solid polymer and an activated monomer liquid. The third step includes removing the solid polymer from the activated monomer liquid in the second mixture to provide an isolated activated monomer liquid. The fourth step includes contacting the isolated activated monomer liquid to a substrate. The activated monomer liquid forms the photo-polymerized polymer on the substrate.

In one respect, the method is performed in the absence of at least one member selected from a group consisting of a photo-sensitizing agent and a peroxide, or a combination thereof. In this respect, the photo-initiating system of the first mixture excludes at least one member selected from a group consisting of a photo-sensitizing agent and a peroxide, or a combination thereof. In another respect, the method is performed in the absence of a thermal treatment as a means of initiating the photo-reaction. However, the method does not exclude thermal treatments or thermal agents that provide benefits directed specifically to curing the activated monomer liquid to form the photo-polymerized polymer on the substrate.

In some respects, the method includes a cationically polymerizable monomer including preferably 3,4-epoxycyclohexylmethyl 3,4-epoxycyclohexanecarboxylate (EEC). Other cationically polymerizable monomers suitable for inclusion in the composition are known in the art, such as vinyl ethers, styrene, N-vinylcarbazole, epoxy monomers, cyclic ethers, lactones, and cyclic acetals. In some respects, the method includes a cationic photo-initiating agent having preferably a diaryliodonium hexafluoroantimonate, such as [4-(2-hydroxyl-1-tetradecyloxy)-phenyl] phenyliodonium hexafluoroantimonate (DAI). Other cationic photo-initiating agents suitable for inclusion in the method are known in the art. In some respects, the method includes a cationically polymerizable monomer including 3,4-epoxycyclohexylmethyl 3,4-epoxycyclohexanecarboxylate (EEC) and a cationic photo-initiating agent having a diaryliodonium hexafluoroantimonate, such as [4-(2-hydroxyl-1-tetradecyloxy)-phenyl] phenyliodonium hexafluoroantimonate (DAI).

In some respects, the substrate includes at least one member selected from a group consisting of a crevice, a crack, a shaped mold, and an angled mold, or a combination thereof. In other respects, the substrate includes other UV-sensitive or visible light-sensitive substrates, such as a biological substrate or electronic component. According to some respects, the second mixture encapsulates the substrate. In some embodiments, the isolated activated monomer liquid can be polymerized between two opaque substrates, two optically thick substrates, two semi-transparent substrates, or any combination of these substrates, because the isolated activated monomer liquid does not depend upon light to form cured polymer on a substrate.

The steps of the method can be repeated with additional polymer layers added as necessary. See, for example, the polymer product described in Example 3.

In some respects, the isolated activated monomer liquid further includes an opaque material or an interfering substance. These aspects can be accomplished after the polymerized solid is removed from the activated monomer liquid of the second mixture to provide isolated activated monomer liquid and thereafter mixing an interfering substance with the isolated activated monomer liquid. In these latter respects, the interfering substance includes at least one member selected from a group consisting of a pigment, a dye, a filler, a reinforcing agent, a coupling agent, a stabilizer, a lubricant, a curing agent, a flame retardant, a biocide agent, an anti-static agent and a nucleating agent, or a combination thereof.

A pigment is a coloring material that produces an opaque polymer compound. Exemplary pigments include titanium dioxide, calcium carbonate, copper phthalocyanine, carbon black, anhydrous Fe₂O₃, oxidehydroxide, FeO(OH), chromium oxide, (Cr₂O₃) and cadmium sulphide and sulphoselenides.

A dye is a coloring material that produces a transparent polymer compound. Exemplary dyes include triphenylmethane dyes (e.g., fuchsine), azo dyes (e.g., methyl orange), anthraquinone dyes (e.g., alizarin), rylene/perylene dyes (e.g., Pigment Violet 29) and indigoid dyes (e.g., tyrianpurple, indirubin, and indigo carmine).

A filler can increase the volume of the polymer and therefore reduces cost; a filler can also improve properties such as reducing shrinkage, thermal expansion, or warping of the resultant polymer compound. Exemplary fillers include wood flour, calcium carbonate, talc (e.g., magnesium silicate), water, mica, asbestos, microspheres, carbon black and aluminum flake.

A reinforcing agent improves structural properties, such as increased stiffness, stability, heat resistance, impact resistance and reduced shrinkage. Exemplary reinforcing agents include glass fibers, carbon or graphite fibers, aramid (aromatic polyamide) fibers and rubber particles.

A coupling agent facilitates the ability of fillers and reinforcing agents to work efficiently. Coupling agents can facilitate the transfer of stress from polymer to reinforcing agent or convert hydrophilic to hydrophobic surface to make polymer and filler more compatible. Exemplary coupling agents include silanes, titanate, and graft and block copolymers.

A stabilizer decreases degradation, such as weathering, which can be caused by exposure to radiation, oxygen, high or low temperatures. Stabilizers include free-radical scavengers and UV absorbers. Exemplary stabilizers include metal oxides, quinone-type organics, Tinuvin 123, Tinuvin 384 (a hydroxybenzotriazole).

A plasticizer reduces modulus and glass transition temperature to make material more flexible. Exemplary plasticizers include sebacates, adipates, terephthalates, dibenzoates, gluterates, phthalates and azelates.

A lubricant can affect the surface coating of a polymer compound or affect the viscosity of the polymer compound. External lubricants migrate out and form a slippery coating for smoother processing operations; internal lubricants are soluble and lower the compound's viscosity. Exemplary external lubricants include stearic acid in the presence of metal salts, paraffin and polyethylene waxes. Exemplary internal lubricants include fatty alcohol, dicarboxylic acid ester and metal soap.

A curing agent can accelerate a reaction, crosslink an initially linear or branched polymer, or facilitate polymerization reactions under different parameters (e.g., a wider UV range). Exemplary curing agents include butanox, cadox, cyclonox, perkadox, trigonox, Aradur 21, Aradur 350, cobalt napthenate, coumarins and curcumin.

A flame retardant reduces flammability of a polymer compound. Exemplary flame retardants include decabromodiphenyl ether, tetrabromobisphenol-A, tetrabromophthalic anhydride, tris(2,3-dibromopropyl) phosphate and hydrated alumina.

The polymer composition can include other miscellaneous additives, such as biocides, anti-static agents and nucleating agents. Exemplary biocides include organic copper, mercury or tin compounds. Exemplary anti-static agents include fatty acid amines. Exemplary nucleating agents include sorbital acetals, sodium benzoate and aromatic carboxylic acid salts.

In a third aspect, a product comprising the photo-polymerized polymer composition produced according to the method of second aspect.

### Formulations

Monomer formulations contain a cationic photo-initiating agent (for example, diazonium salts, onium salts, and organometallic derivatives) such as a diaryliodonium hexafluoroantimonate (for example, [4-(2-hydroxyl-1-tetradecyloxy)-phenyl] phenyliodonium hexafluoroantimonate (DAI)) and a cationically polymerizable monomer (for example, vinyl ethers, styrene, N-vinylcarbazole, epoxy monomers, cyclic ethers, lactones, and cyclic acetals) such as 3,4-epoxycyclohexylmethyl 3,4-epoxycyclohexanecarboxylate (EEC). Other photo-initiating systems having greater complexity, such as the photo-initiating system reported in U.S. Pat. No. 6,245,827 B1 as comprising a cationic photo-initiating agent, a photo-sensitizing agent and a peroxide, are not needed to achieve the shadow cure effect described according to the present invention. Accordingly, the photo-polymerizable polymer compositions and methods for producing polymer compositions lack or otherwise specifically exclude at least one of a photo-sensitizing agent and a peroxide, or a combination thereof.

Material costs can be reduced and safety improved if only a cationic photo-initiating agent is used. Without the scope of the invention being limited by any particular theory, the inability to incorporate unreacted parts of the photo-initiating system or their fragments into the polymer matrix after illumination can result in these additives leeching out from the polymer matrix and cause potential health and safety concerns depending upon their concentration and chemistry. Furthermore, in the case of heat-sensitive applications such as electronics or biomedical applications, excluding an external source of thermal treatment can prove beneficial. A radiation source is used to generate the cationic active centers, through which the polymer chains propagate (grow). These cationic active centers are long-lived and persist after the radiation source is turned off. A preferred radiation source is one having a spectral output that matches the absorption profile of the cationic photo-initiator system used in the method.

### Original Shadow Cure Method

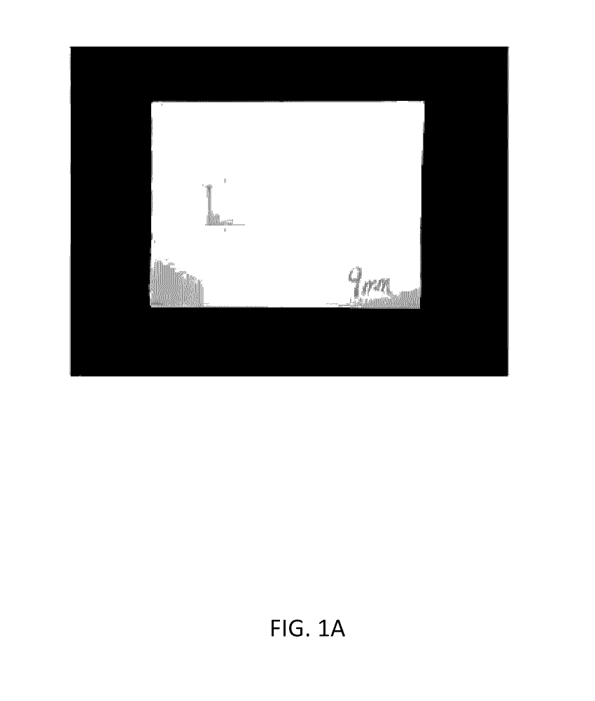

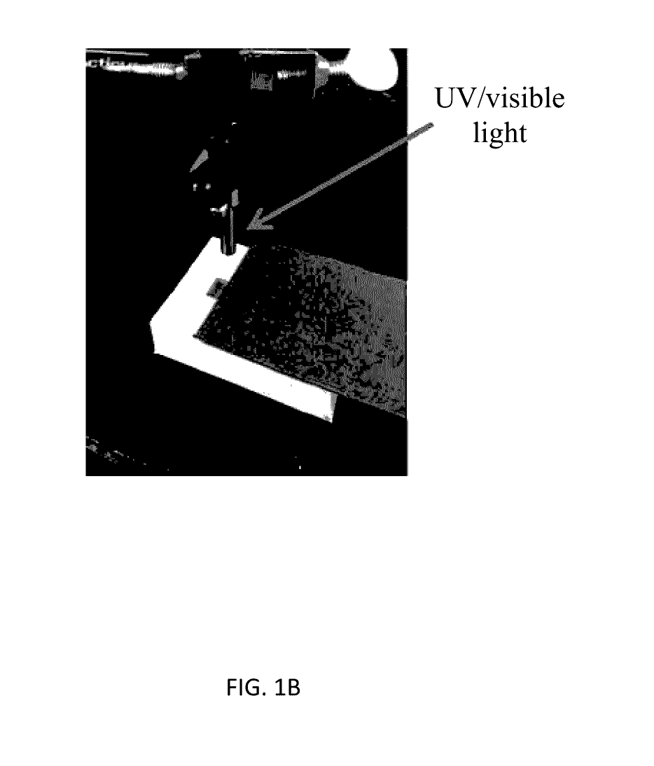

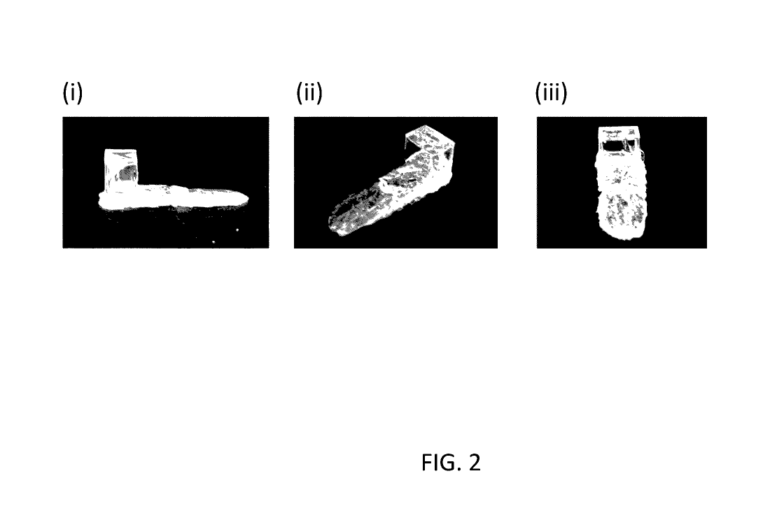

The original shadow cure method included filling a channel (for example, one having dimensions of 10 mm (width)×40 mm (length)×9 mm (depth)) of a PDMS mold (polydimethylsiloxane, also known as silicon rubber) with a cationic formulation, covering the length of the channel except a small area, and irradiating that small exposed area (typically 0.5 cm²) with light (FIG. 1). The area exposed to light is considered the light-cured region, and the covered area is considered the shadow-cure region. The sample is preferably left in the mold for at least 48 hours, during which time it is stored in the dark. Shadow-cure samples formed using this method have a distinctive shape (FIG. 2) and much of the monomer in the channel is wasted, as it remains a liquid. The shadow-cure samples have a volume of cure directly beneath the light-cured section of the sample; sometimes this section of shadow cure extends out laterally from the light-cured section.

In some instances, the remaining monomer can be reused. The remaining monomer may have short, oligomer chains, a reduced amount of photo-initiating agent (compared to the original formulation), or initiator fragments; however, the potential unused monomer compositions were not studied.

This first section of shadow cure is loosely connected to a layer of shadow cure on the bottom of the mold. The length of this bottom section of shadow cure depends on the curing factors (light intensity, channel depth, etc.) but has the ability to extend the length of the mold (4 cm). A few strands of polymer are between the top and bottom sections of shadow cure, often enough to connect the two main pieces, but not much more, and a reservoir of monomer. In an effort to remove this gap between shadow-cure pieces, molds with shallower channel depths were tried. However, this gap persists, albeit smaller. Also, decreasing the depth of the channel decreases the amount and length of shadow cure. For examples, molds can vary in depth from 3 mm to 9 mm, light intensities from 10 to 170 mW/cm², exposure times that range from 1 to 10 minutes, and a wavelength range of 250 to 450 nm, and a range of cationic photo-initiator concentrations from about 0.0075 wt % to 2 wt %. At a certain depth (for example, below about 0.5 mm depth) no measurable shadow cure is gained. Channel depth is necessary for the diffusion of the active centers out of the light-cured region.

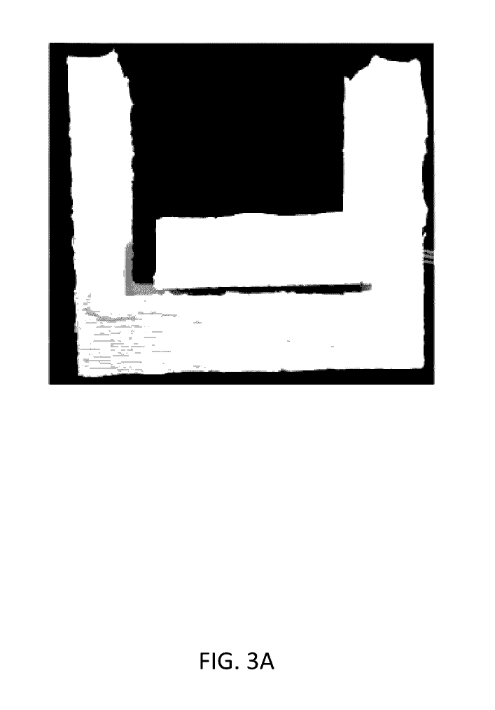

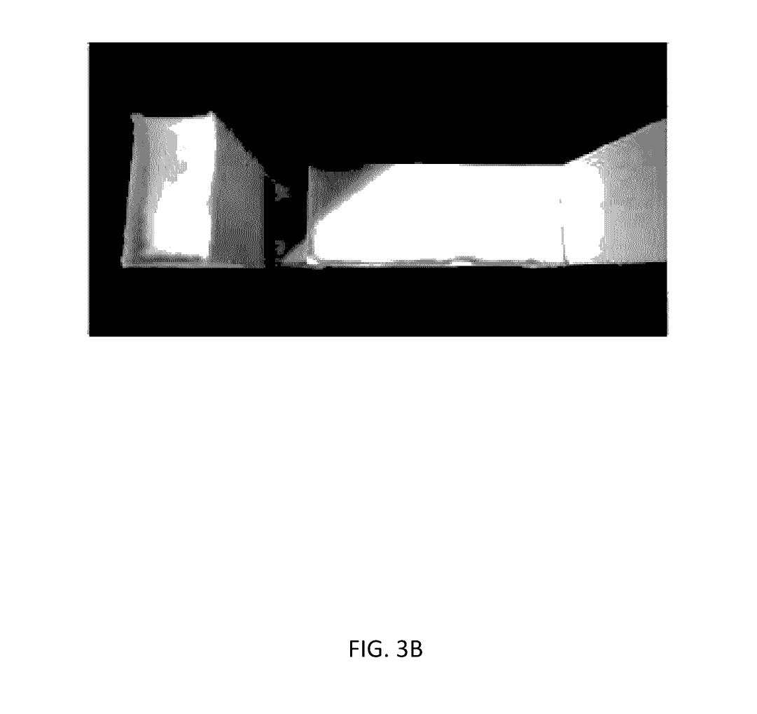

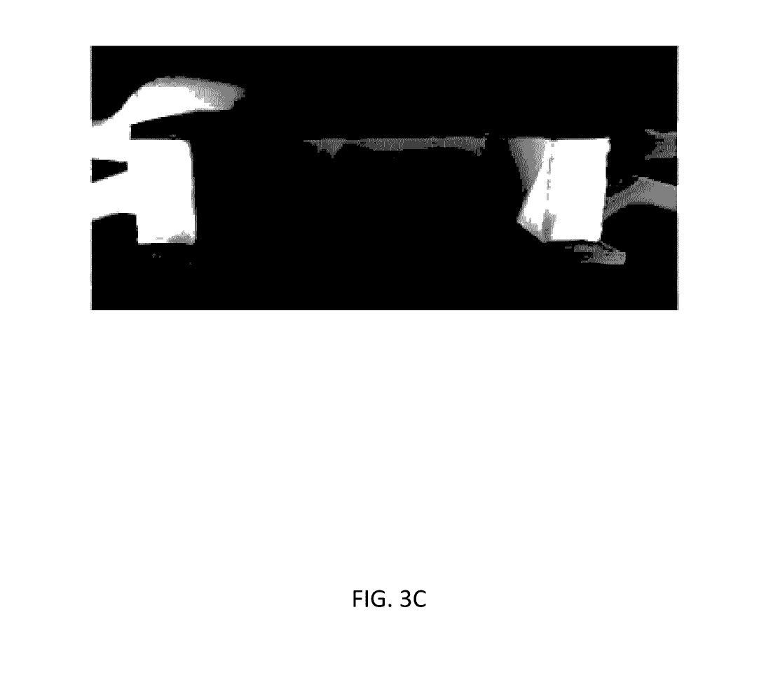

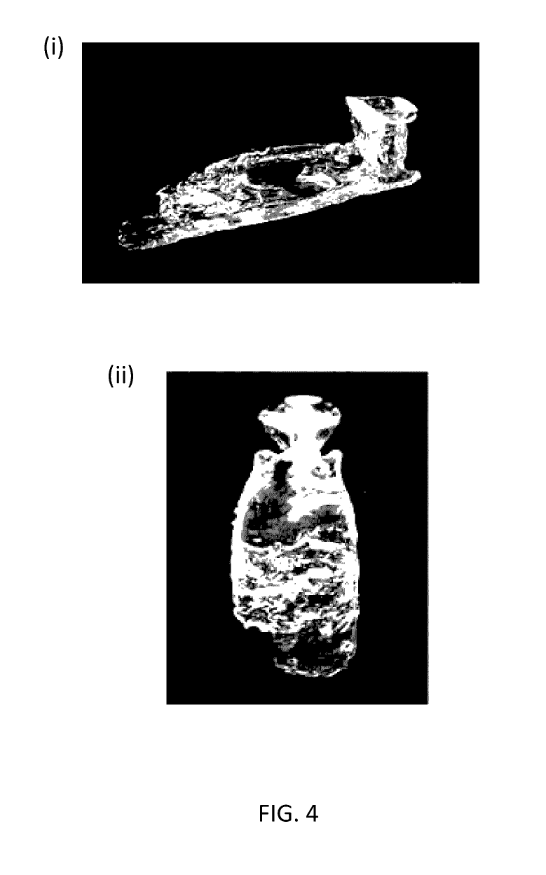

A mold, simulating a crack or crevice, can be adapted to fit the diffusion of the active centers into the shadow-cure region (FIG. 3). This mold wastes less resin formulation and shows the potential for “light curing” in regions that cannot be exposed to light (FIG. 4). However, curing in this manner would require a “monomer well” to be placed outside of the crack/crevice, which still wastes some materials and would require placement and removal pre-cure and post-cure, respectively.

### Improved Shadow Cure Method A

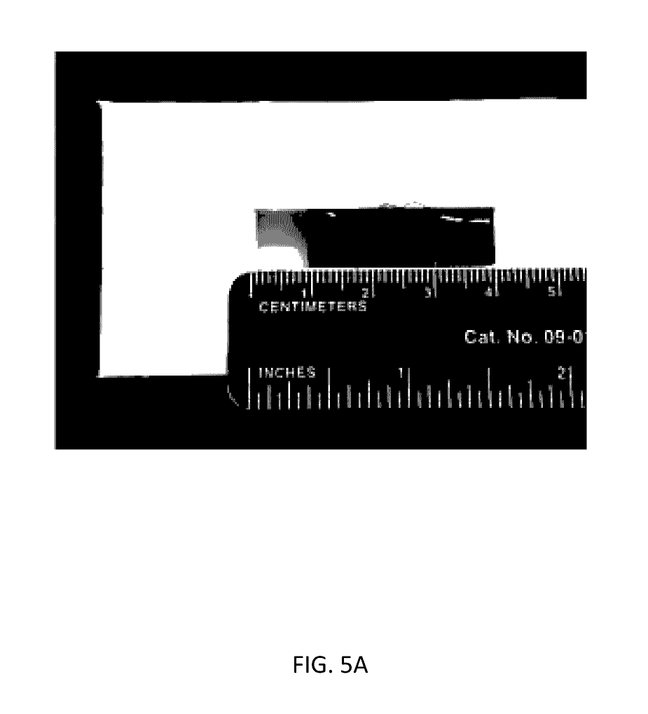

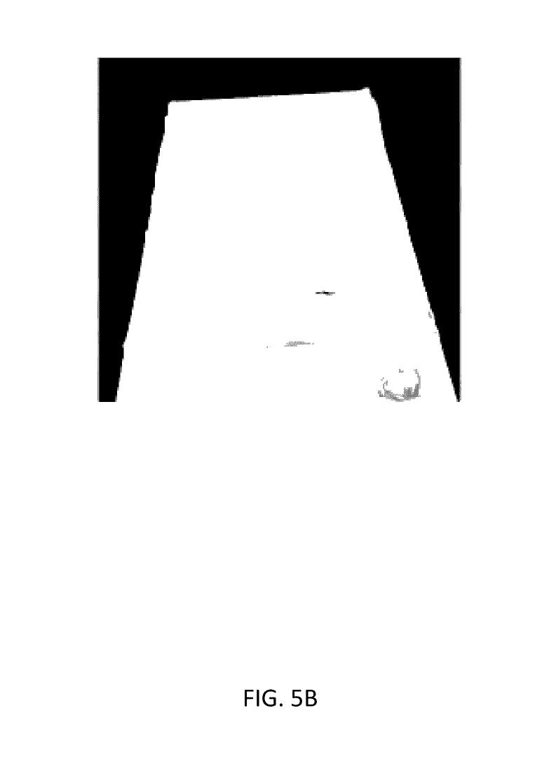

A new method of shadow curing that eliminates many of the disadvantages of the original method is presented. Essentially, in this new method, the light-cured section (solid polymer created during exposure to light) is removed either immediately post-cure or within 10 to 15 minutes, and the exposure area/monomer volume ratio is controlled. The exposure area/monomer volume ratio can be controlled with a piece of dried hot glue to reduce channel size (for example, from a 1 cm×4 cm×6 mm channel to a 1 cm×1 cm×6 mm channel) (FIG. 5A). This reduced space is filled with monomer, then the whole 1 cm² surface area is exposed to light. The light-cured section and glue is removed, allowing the remaining liquid resin to fill the original length of the mold (4 cm) (FIG. 5B).

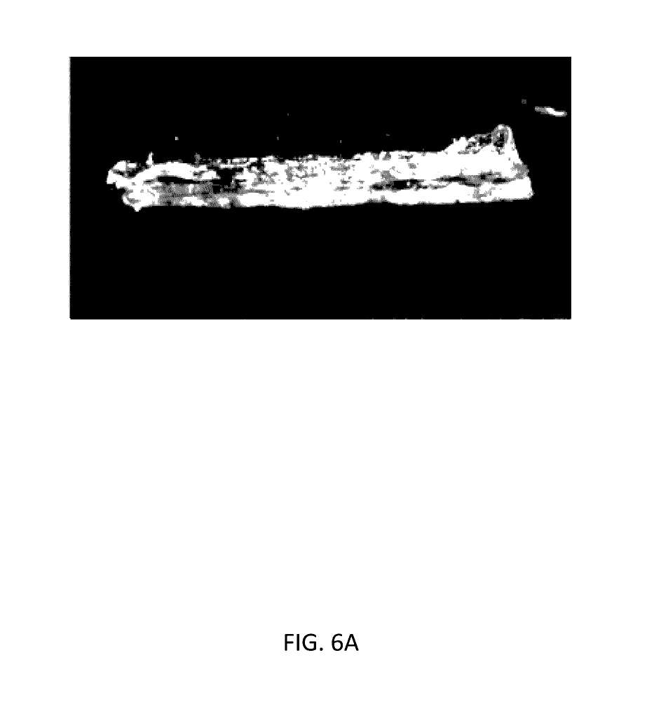

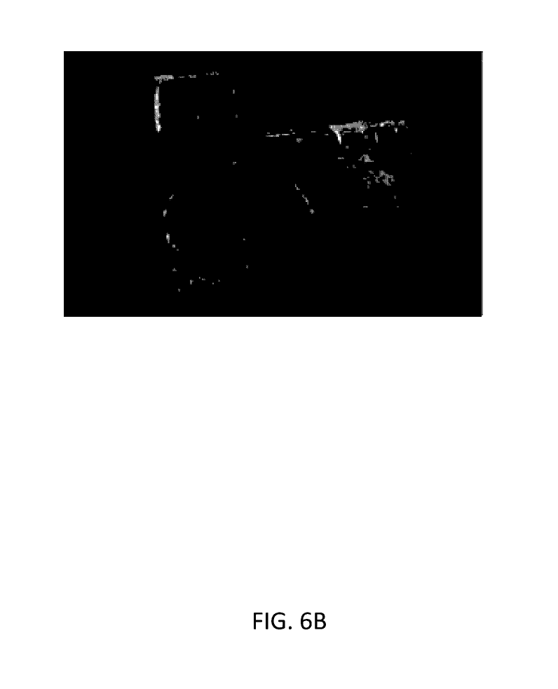

The sample is then stored in the dark, typically for at least 48 hrs. When the sample is later removed, there is little to no residual liquid, and there is only one section of shadow cure, which fills the volume of the mold previously occupied by the liquid resin (FIG. 6A). This new method of shadow cure retains the ability of the previous method to cure around corners in various shapes (FIG. 6B). One can transfer the liquid resin (remaining after the removal of the light-cured section) to virtually any space and have it cure. This active-center-containing monomer can be transferred to crevices/cracks ranging from, for example, 300-μm to 2 cm thicknesses. Despite the thickness of the crevice, shadow cure is observed. The ability to transfer the active-center-containing monomer and produce a solid polymer, without further exposure to light, greatly expands the applications of shadow cure.

### Improved Shadow Cure Method B

The active-center containing monomer (the liquid resin that is left after the light-cured section is removed) can be diluted with pure monomer before it polymerizes and still polymerize effectively. In the shadow cure method A, a preferred sample depth is 6 mm if the exposure area is 1 cm². The resultant sample is a mixture of monomer and photo-initiator, but the photo-initiator molecules at the bottom of the sample are wasted because they are never exposed to light.

The active-center containing monomer from a 1 cm²×3 mm mold can be mixed with the same volume of pure monomer (so the total volume is now 1 cm²×6 mm) and still polymerize. Photo-initiator is often the most expensive ingredient of the formulation, so being able to reduce the amount used is a cost-saving measure. Additionally, photo-initiator fragments or unused photo-initiator molecules can migrate out of the polymer over time and can be toxic if ingested. Reducing the concentration of photo-initiator used in the polymerization can facilitate compliance with government food and safety guidelines.

### Central Composite Design and Response Surface Profiles

A central composite design (CCD) can be used to predict the outcome (polymer conversion) of the transferrable shadow cure based on four user inputs (effective irradiance, exposure area, exposure time, and sample depth). A CCD is derived from the design-of-experiments concepts. A CCD is constructed for a specific polymer composition and system (for example, in this instance, the polymer composition is EEC in the presence of 0.5 wt % DAI; the system includes use of the following conditions: ambient temperature (70° F.); light wavelengths 250 nm to 450 nm; and 6 days shadow cure time). An identical design can be created for any polymer composition and system described herein. Instead of collecting information from a few hundred samples to understand how the four user inputs interact and influence the polymer conversion, the CCD reduces that number to 30 samples, all of which are strategically chosen. All of the data is collected and put into a design-of-experiments program, Design Expert (Stat-Ease, Inc. (Minneapolis, Minn. (US))). The program calculates a predictive equation from the user input parameters, which is visualized in a response surface graph. For example, the equation for polymer conversion is presented in Eqn. (I):

Average Conversion=+0.43594+0.017134×(Effective Irradiance)−0.017134×(Sample Depth)×+0.015497×(Exposure Time)|5.58878×10⁻³×(Exposure Area) (Eqn. (I)).

The variables are expressed in terms of factor level for use in the equation. In this case, an exemplary set of factor levels is presented in Table I.

TABLE I
Factor levels for parameters of Eqn. (I).

| Factor Level: | −2 | | −1 | | 0 | | +1 | | +2 | |
|---|---|---|---|---|---|---|---|---|---|---|
| Eff. Irradiance | 10 | mW/cm² | 32.5 | mW/cm² | 55 | mW/cm² | 77.5 | mW/cm² | 100 | mW/cm² |
| Sample Depth | 3 | mm | 4.5 | mm | 6 | mm | 7.5 | mm | 9 | mm |
| Exposure Time | 1 | min | 3.25 | min | 5.5 | min | 7.75 | min | 10 | min |
| Exposure Area | 0.3 | cm² | 0.4 | cm² | 0.5 | cm² | 0.6 | cm² | 0.7 | cm² |

For example, to understand how an effective irradiance of 10 mW/cm² affects the conversion of polymer, a factor level of −2 for the effective irradiance variable is inputted into the equation. The equation is also only valid over the factor space presented in Table I (10 to 100 mW/cm² effective irradiance, 1 to 10 min exposure time, etc.).

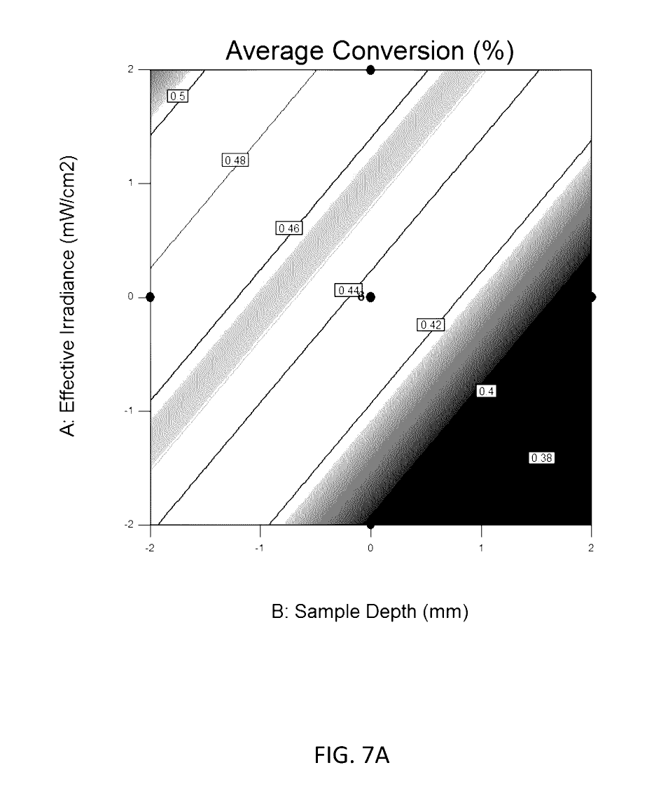

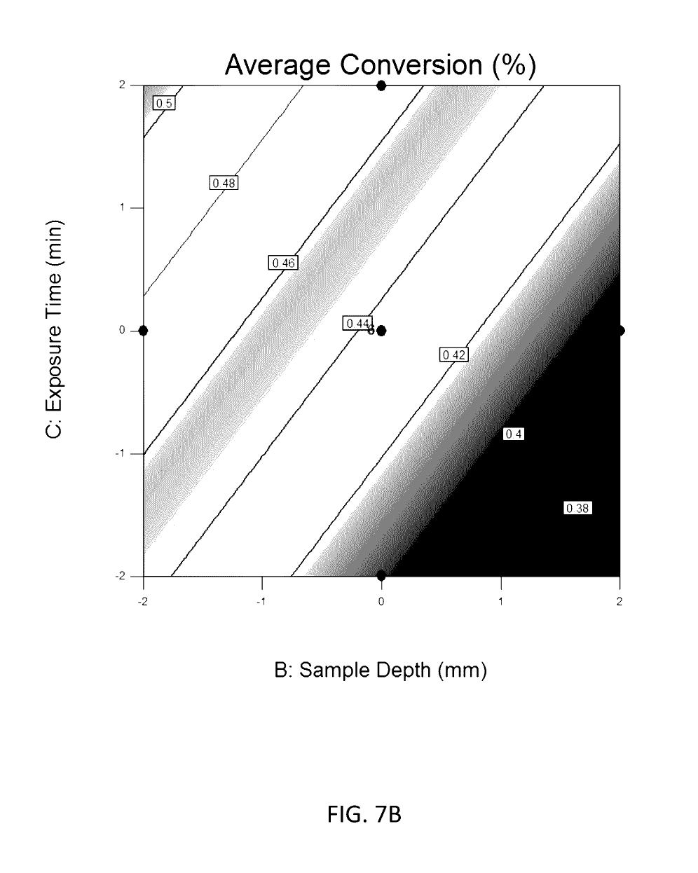

FIGS. 7A and 7B depicts exemplary response surface profiles from the CDD. The response profile is a visual representation of Eqn (I). FIG. 7A presents a response profile where the factor levels of exposure time and exposure area were set to 0 (that is, exposure time was 5.5 minutes and exposure area was 0.5 cm² for all samples tested as a function of effective irradiance and sample depth). FIG. 7B presents a response profile where the factor levels of effective irradiance and exposure area were set to 0 (that is, effective irradiance was 55 mW/cm² and exposure area was 0.5 cm² for all samples tested as a function of exposure time and sample depth).

Ten additional transferrable shadow cure samples were prepared and their polymer conversion was evaluated to assess the validity of the design equation as a predictive tool. The design equation was used to predict the conversion of each of these ten samples, based on the input factor levels. The predicted conversion is then compared to the experimental conversion. For this design, the error between predicted and experimental conversion was less than 5% for all ten samples.

### Apparatus and Reaction Vessel for Forming a Photo Polymerized Polymer

One significant drawback to the transferrable shadow cure method is the need to remove the light-cured section. The removal adds steps and time to the process and makes it difficult to automate and scale up, which pose disadvantages.

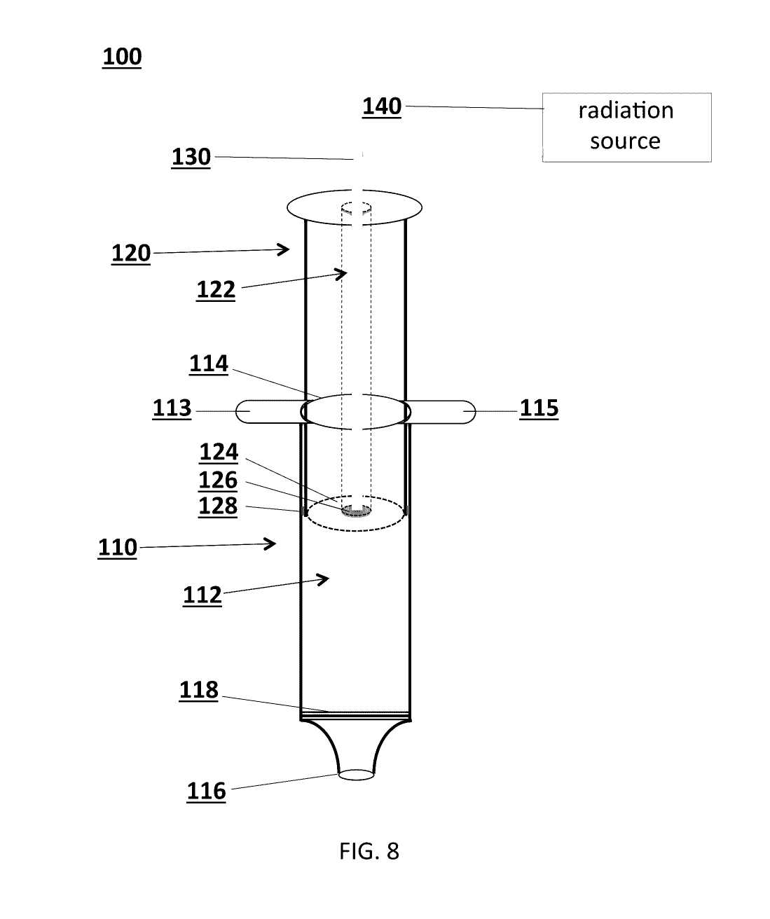

Referring to FIG. 8, apparatus 100 can be used with the transferrable shadow cure methods to eliminate these disadvantages. Apparatus 100 includes barrel 110, plunger 120, light guide optic fiber 130 and radiation source 140.

Barrel 110 includes a first cavity 112. First cavity 112 extends the length of barrel 110 and includes open first end 114 and open second end 116. Preferably, open second end 116 is narrower than open first end 114. Mesh 118 is disposed above open second end 116. Optionally, barrel 110 can include first and second protrusions 113 and 115 that project away from the open first end 114. First and second protrusions 113 and 115 enable apparatus 100 to be manipulated by hand in cases were apparatus is used in non-automated procedures (for example, manual operation by hand).

Barrel 110 is composed preferably of UV-resistant and heat-resistant material. Preferred compositions of barrel 110 include materials such as polypropylene, polystyrene, borosilicate glass or quartz glass. Barrel 110 is preferably composed of opaque material. The advantages for using opaque material includes preventing premature polymerization of the liquid resin disposed in first cavity 112 of barrel 110 by ambient light and reducing the amount of UV-exposure to the user from light guide optic fiber 130. In some embodiments, wherein barrel 110 is composed of opaque material, it is desirable to include a small transparent window section on barrel and/or markings on plunger 120 to enable measurement of volumes in first cavity 112 of barrel 110.

Plunger 120 is disposed in the first cavity 112 of barrel 110. Plunger 120 includes a second cavity 122. Base 124 of plunger 120 includes optically transparent window 126. Preferably, plunger 120 forms a vacuum seal with barrel 110 when plunger 120 is disposed in first cavity 112 of barrel 110. Optionally, plunger 120 includes outer gasket seal 128 surrounding base 124 to provide a vacuum seal with barrel 110 when plunger 120 is positioned in first cavity 112 of barrel 110. Preferred compositions of plunger 120 include materials such as polypropylene, polystyrene, borosilicate glass or quartz glass. Preferably, the compositions of barrel 110 and plunger 120 are the same for a given apparatus 100.

Light guide optic fiber 130 is positioned in the second cavity 122 such that light guide optic fiber 130 is proximal to optically transparent window 126. Light guide optic fiber 130 is in optical communication with radiation source 140.

The liquid resin can be drawn up into first cavity 112 of barrel 110 via open second end 116 by withdrawing plunger 120 from first cavity 112 via open first end 114. The liquid resin is exposed to light via light guide optic fiber 130 to initiate photo-polymerization. The active-center containing resin can be expelled/released from first cavity 112 by displacing plunger 120 towards open second end 116 of barrel 110 while the light-cured section is trapped against mesh 118 of barrel 110. Conventional or commercially available syringes can be modified to accommodate the design of apparatus 100. The design of apparatus 100 permits automation and scale-up.

In another aspect, a reaction vessel for forming a photo-polymerized polymer is provided. The reaction vessel includes a barrel 110 and a plunger 120 (see FIG. 8). Barrel 110 includes a first cavity 112. First cavity 112 extends the length of barrel 110 and includes open first end 114 and open second end 116. Preferably, open second end 116 is narrower than open first end 114. Mesh 118 is disposed above open second end 116. Optionally, barrel 110 can include first and second protrusions 113 and 115 that project away from the open first end 114. First and second protrusions 113 and 115 enable apparatus 100 to be manipulated by hand in cases were apparatus is used in non-automated procedures (for example, manual operation by hand).

Barrel 110 is composed preferably of UV-resistant and heat-resistant material. Preferred compositions of barrel 110 include materials such as polypropylene, polystyrene, borosilicate glass or quartz glass. Barrel 110 is preferably composed of opaque material. The advantages for using opaque material includes preventing premature polymerization of the liquid resin disposed in first cavity 112 of barrel 110 by ambient light and reducing the amount of UV-exposure to the user from light guide optic fiber 130. In some embodiments, wherein barrel 110 is composed of opaque material, it is desirable to include a small transparent window section on barrel and/or markings on plunger 120 to enable measurement of volumes in first cavity 112 of barrel 110.

Plunger 120 is disposed in the first cavity 112 of barrel 110. Plunger 120 includes a second cavity 122. Second cavity 122 has sufficient volume to accommodate a light guide optic fiber in optical communication with a radiation source. Base 124 of plunger 120 includes optically transparent window 126. Preferably, plunger 120 forms a vacuum seal with barrel 110 when plunger 120 is disposed in first cavity 112 of barrel 110. Optionally, plunger 120 includes outer gasket seal 128 surrounding base 124 to provide a vacuum seal with barrel 110 when plunger 120 is positioned in first cavity 112 of barrel 110. Preferred compositions of plunger 120 include materials such as polypropylene, polystyrene, borosilicate glass or quartz glass. Preferably, the compositions of barrel 110 and plunger 120 are the same for a given apparatus 100.

Applications of the method of shadow curing include application of photopolymerization in manufacturing processes that are not amenable to light penetration (i.e., decoupling the photo-initiation step from the propagation step). These possible applications are further exemplified by the following non-limiting applications: (a) transference of the active-center-containing mixture to opaque molds for polymerization; (b) mixing the active-center-containing mixture with pigments, dye, and/or other interfering substances that would have reduced or greatly inhibited photo-initiation; (c) transference of the active-center-containing monomer to sites for which photo-initiation with UV light would be detrimental, such as in vivo applications; (d) transference of the active-center-containing mixture to sites in which light penetration is not possible for the entire sample, such as long crevices, molds with complicated shapes and angles, deep cracks, and encapsulation of complex parts; and (e) injection of the active-center-containing mixture into a mold after illuminating one end of a fillable mold, such as a syringe (thereby trapping the light-cured portion in the syringe barrel).

### Examples

The invention will be more fully understood upon consideration of the following non-limiting examples, which are offered for purposes of illustration, not limitation.

### Example 1

The 4-epoxycyclohexylmethyl 3,4-epoxycyclohexanecarboxylate (EEC) was obtained from Sigma-Aldrich Corp. (St. Louis, Mo. (US)). The [4-(2-hydroxyl-1-tetradecyloxy)-phenyl] phenyliodonium hexafluoroantimonate (DAI, trade name PC-2506) was obtained from Polyset Co. Inc. (Mechanicville, N.Y. (US)).

The EEC was mixed with 0.5 wt % DAI, then sonicated for 60 minutes or until the DAI was fully dissolved in the EEC. The volume of a 10 mm×40 mm×9 mm PDMS mold (made using Alumilite Quick-Set RTV silicone rubber) was reduced to 10 mm×10 mm×9 mm with the addition of a dried length of hot glue, and the EEC/DAI mixture was pipetted into the mold until the mixture filled the reduced volume. The configuration was then exposed to UV/visible light of the wavelength range 250-450 nm, produced by an Omnicure S1000 mercury arc lamp (Excelitas). The effective irradiance was 30 mW/cm² and the exposure time 5 minutes. Illumination occurred at ambient temperature (˜70° F.). Immediately after light exposure, the light-cured section (solid polymer) was separated from the active-center containing monomer (liquid beneath the solid polymer) and was removed from the mold with the length of hot glue. The active-center containing monomer was transferred via pipet to a T-shaped PDMS mold and placed in a dark space for ˜48 hours, at ambient temperature (˜70° F.). The cured polymer was removed from the mold.

### Example 2

The 4-epoxycyclohexylmethyl 3,4-epoxycyclohexanecarboxylate (EEC) and Calcium carbonate were obtained from Sigma-Aldrich Corp. (St. Louis, Mo. (US)). The [4-(2-hydroxyl-1-tetradecyloxy)-phenyl] phenyliodonium hexafluoroantimonate (DAI, trade name PC-2506) was obtained from Polyset Co. Inc. (Mechanicville, N.Y. (US)).

The EEC was mixed with 0.5 wt % DAI, then sonicated for 60 minutes or until the DAI was fully dissolved in the EEC. The volume of a 10 mm×40 mm×9 mm PDMS mold (made using Alumilite Quick-Set RTV silicone rubber) was reduced to 10 mm×10 mm×9 mm with the addition of a dried length of hot glue (FIG. 5A), and the EEC/DAI mixture was pipetted into the mold until the mixture filled the reduced volume. The configuration was then exposed to UV/visible light of the wavelength range 250-450 nm, produced by an Omnicure S1000 mercury arc lamp (Excelitas). The effective irradiance was 30 mW/cm² and the exposure time 5 minutes. Illumination occurred at ambient temperature (˜70° F.). Immediately after light exposure, the light-cured section (solid polymer) was separated from the active-center containing monomer (liquid beneath the solid polymer) and was removed from the mold with the length of hot glue. Approximately 10 wt % calcium carbonate was stirred into the active-center containing monomer. The resultant mixture was then transferred via spatula to a polystyrene weigh boat, where it was allowed to polymerize in an amorphous shape in a dark space for ˜48 hours, at ambient temperature (˜70° F.). The cure polymer was removed from the weigh boat.

### Example 3

The 4-epoxycyclohexylmethyl 3,4-epoxycyclohexanecarboxylate (EEC) was obtained from Sigma-Aldrich Corp. (St. Louis, Mo. (US)). The [4-(2-hydroxyl-1-tetradecyloxy)-phenyl] phenyliodonium hexafluoroantimonate (DAI, trade name PC-2506) was obtained from Polyset Co. Inc. (Mechanicville, N.Y. (US)). Carbon black with a particle size of ˜31 nm (trade name NIPex 35) was obtained from Degussa AG (Frankfurt, Germany). The traffic yellow polyethylene particles (trade name G17SE111C50-2 Extra Traffic Yellow) were obtained from PolyArmor USA (Seal Beach, Calif. (US)).

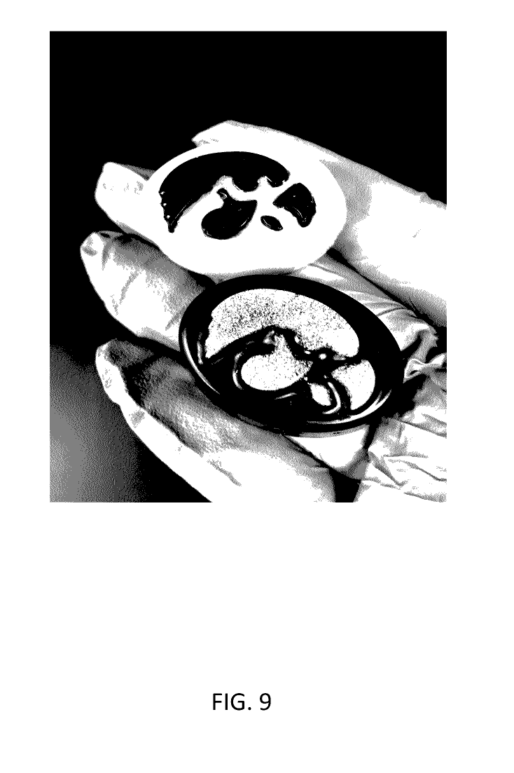

The EEC was mixed with 0.5 wt % DAI, then sonicated for 60 minutes or until the DAI was fully dissolved in the EEC. The volume of a 10 mm×40 mm×9 mm PDMS mold (made using Alumilite Quick-Set RTV silicone rubber) was reduced to 10 mm×10 mm×9 mm with the addition of a dried length of hot glue (FIG. 5A), and the EEC/DAI mixture was pipetted into the mold until the mixture filled the reduced volume. The configuration in Step 2 was exposed to UV/visible light of the wavelength range 250-450 nm, produced by an Omnicure S1000 mercury arc lamp (Excelitas). The effective irradiance was 30 mW/cm² and the exposure time 5 minutes. Illumination occurred at ambient temperature (˜70° F.). Immediately after light exposure, the light-cured section (solid polymer) was separated from the active-center containing monomer (liquid beneath the solid polymer) and was removed from the mold with the length of hot glue. The active-center containing monomer was mixed with approximately 1 wt % of carbon black, then transferred via spatula to a PDMS mold of the University of Iowa Hawkeye logo. The preceding steps were repeated and the active-center containing monomer was mixed with approximately 2 wt % traffic yellow, then transferred via spatula to the same PDMS mold, where it was layered on top of the carbon black-containing mixture. This step was repeated until the mold was filled. [Repetition was required due to a limited light spot size, and thus, a limited exposure area/monomer volume ratio. A larger light spot size would eliminate the need for repetition]. The filled mold was then placed in a dark space for ˜72 hours, at ambient temperature (˜70° F.). The cured polymer was removed from the mold (FIG. 9). An identical example with the pigments reversed (traffic yellow used initially, followed by use of carbon black) was also produced using this method.

### INCORPORATION BY REFERENCE

All of the patents, patent applications, patent application publications and other publications recited herein are hereby incorporated by reference as if set forth in their entirety.

The present invention has been described in connection with what are presently considered to be the most practical and preferred embodiments. However, the invention has been presented by way of illustration and is not intended to be limited to the disclosed embodiments. Accordingly, one of skill in the art will realize that the invention is intended to encompass all modifications and alternative arrangements within the spirit and scope of the invention as set forth in the appended claims.

The invention claimed is:

1. A photo-polymerizable composition for preparing a polymer, comprising:
a cationically polymerizable monomer; and
a photo-initiating system comprising a cationic photo-initiating agent.

2. The photo-polymerizable composition of claim 1, wherein the photo-initiating system excludes at least one member selected from a group consisting of a photo-sensitizing agent and a peroxide, or a combination thereof.

3. The photo-polymerizable composition of claim 1, wherein the cationically polymerizable monomer comprises 3,4-epoxycyclohexylmethyl 3,4-epoxycyclohexanecarboxylate.

4. The photo-polymerizable composition of claim 1, wherein the cationic photo-initiating agent comprises a diaryliodonium hexafluoroantimonate.

5. The photo-polymerizable composition of claim 1, wherein the cationically polymerizable monomer comprises 3,4-epoxycyclohexylmethyl 3,4-epoxycyclohexanecarboxylate and the cationic photo-initiating agent comprises a diaryliodonium hexafluoroantimonate.

6. A method of forming a photo-polymerized polymer on a substrate, comprising;
preparing a first mixture comprising:
a cationically polymerizable monomer; and
a photo-initiating system comprising a cationic photo-initiating agent;
irradiating the first mixture with UV and/or visible light to form a second mixture, wherein the second mixture comprises a solid polymer and an activated monomer liquid;
removing the solid polymer from the activated monomer liquid in the second mixture to provide an isolated activated monomer liquid; and
contacting the isolated activated monomer liquid to a substrate, wherein the activated monomer liquid forms the photo-polymerized polymer on the substrate.

7. The method of claim 6, wherein the method is performed with a photo-initiating system excluding at least one member selected from a group consisting of a photo-sensitizing agent and a peroxide, or a combination thereof.

8. The method of claim 6, wherein the method is performed in the absence of a thermal initiator.

9. The method of claim 6, wherein the cationically polymerizable monomer comprises 3,4-epoxycyclohexylmethyl 3,4-epoxycyclohexanecarboxylate.

10. The method of claim 6, wherein the cationic photo-initiating agent comprises a diaryliodonium hexafluoroantimonate.

11. The method of claim 6, wherein the cationically polymerizable monomer comprises 3,4-epoxycyclohexylmethyl 3,4-epoxycyclohexanecarboxylate and the cationic photo-initiating agent comprises a diaryliodonium hexafluoroantimonate.

12. The method of claim 6, wherein the substrate comprises at least one member selected from a group consisting of a crevice, a crack, a shaped mold, and an angled mold, or a combination thereof.

13. The method of claim 6, wherein the substrate comprises a light or UV-light sensitive substrate.

14. The method of claim 6, wherein the isolated activated monomer liquid encapsulates the substrate.

15. The method of claim 6, further comprising contacting the isolated activated monomer liquid to an additional substrate,
wherein the isolated activated monomer liquid lies in between the substrate and the additional substrate,
wherein the substrate and additional substrate are selected from the group consisting of opaque substrates, optically-thick substrates and semi-transparent substrates, or a combination thereof.

16. The method of claim 6, further comprising mixing an interfering substance with the isolated activated monomer liquid.

17. The method of claim 16, wherein the interfering substance comprises at least one member selected from a group consisting of a pigment, a dye, a filler, a reinforcing agent, a coupling agent, a stabilizer, a lubricant, a curing agent, a flame retardant, a biocide agent, an anti-static agent and a nucleating agent, or a combination thereof.

18. A product comprising a photo-polymerized polymer composition produced according to the method of claim 6.

19. An apparatus for forming a photo-polymerized polymer, said apparatus comprising:
a barrel having a first cavity;
a plunger having a second cavity, wherein the plunger is disposed in the first cavity;
a light guide optic fiber, wherein the light guide optic fiber is disposed in the second cavity; and
a radiation source,
wherein the light guide optic fiber is in optical communication with the radiation source.

20. The apparatus of claim 19, further comprising an optically transparent window being disposed at the base of the second cavity, wherein the light guide optic fiber is proximal to the optically transparent window.

21. The apparatus of claim 19, wherein the barrel and the plunger comprise materials selected from a group consisting of polypropylene, polystyrene, borosilicate glass and quartz glass.

22. The apparatus of claim 19, wherein the barrel comprises an optically opaque material.

23. The apparatus of claim 19, wherein the barrel further comprises a mesh at the base of the first cavity.

24. The apparatus of claim 19, wherein the plunger further comprises a gasket seal.

25. A reaction vessel for forming a photo-polymerized polymer, said reaction vessel comprising:
a barrel having a first cavity, wherein a mesh is disposed at an open end of the first cavity; and
a plunger having a second cavity, wherein the plunger is disposed in the first cavity.

26. The reaction vessel of claim 25, further comprising a light guide optic fiber,
wherein the light guide optic fiber is disposed in the second cavity, and
wherein the light guide optic fiber is in optical communication with a radiation source.
